(19) United States
(12) Patent Application Publication
(10) Pub. No.: US 2026/0296360 A1
(43) Pub. Date: Oct. 1, 2026

(54) ACTIVE PEDESTRIAN HOOD HINGE WITH POWERED ACTUATOR

(71) Applicant: MAGNA CLOSURES INC., Newmarket (CA)

(72) Inventor: Gregor NEUMANN, Newmarket (CA)

(21) Appl. No.: 19/574,256

(22) Filed: Mar. 20, 2026

Related U.S. Application Data
(60) Provisional application No. 63/781,463, filed on Apr. 1, 2025.

(51) Int. Cl. B60R 21/38; E05D 3/14; E05F 15/73

(52) U.S. Cl. CPC B60R 21/38; E05D 3/145; E05F 15/73; E05Y 2900/536

(57) ABSTRACT

A hood hinge for a vehicle hood panel configured to close off a space of a vehicle body. The hood hinge includes a hood bracket for connection to the vehicle hood panel and a body bracket for connection to the vehicle body. A pivot arrangement between the hood bracket and the body bracket allowing the vehicle hood panel to move between a closed position, a normal open position, and a partially opened active pedestrian protection position. A first actuator connected to the hood bracket. In a normal mode, the first actuator configured to move the vehicle hood panel from the closed position to the normal open position and from the normal open position to the closed position, and in an active pedestrian protection mode, to move the vehicle hood panel from the closed position to the partially opened active pedestrian position.

### CROSS-REFERENCE TO RELATED APPLICATIONS

This application claims the benefit of U.S. Provisional Application Ser. No. 63/781,463, filed Apr. 1, 2025, which is incorporated herein by reference in its entirety.

### FIELD

The present disclosure relates generally to hinges of the type used in motor vehicles to support a closure member for movement between open and closed positions. In particular, the present disclosure is directed to a hinge assembly constructed of at least one composite hinge component and configured for use with a vehicle hood.

### BACKGROUND

This section provides background information related to the present disclosure which is not necessarily prior art.

In recent years, a great deal of emphasis has been directed to development of pedestrian protection systems for use in motor vehicles in an effort to reduce the likelihood or severity of injuries caused during a collision between a pedestrian and a motor vehicle. One such area of development has been directed to equipping the motor vehicle with a hood assembly capable of absorbing impact forces.

A “passive” pedestrian protection system associated with the hood assembly includes a pocket of under-hood crush space provided between the hood and the components within the vehicle's engine compartment. This crush space is configured to reduce the chance of bodily impact with the components within the engine compartment and, more particularly, to provide an impact absorbing feature. However, the use of low profile hoods in modern motor vehicles for improved aesthetics and aerodynamics, in combination with smaller engine compartments, limits the available crush space.

As an alternative, an “active” pedestrian protection system associated with the vehicle's hood assembly provides a “deployable” hood that is configured to raise a rear portion of the latched hood to create the additional under-hood crush space. This deployable hood feature is activated in response to detection of a pedestrian collision with the front end of the motor vehicle. Typically, a pair of active hinges are incorporated into the hood assembly. Each active hinge includes a pivot linkage interconnecting the hood to the vehicle body and an actuator that is operable to forcibly move the pivot linkage for causing the hood to move from a non-deployed position to a deployed position in response to detection of the pedestrian impact. Examples of active hinges that provide this functionality are disclosed in commonly-owned U.S. Pat. No. 8,544,590 and U.S. Publication No. 2014/0182962. One drawback associated with active hinges formed from metal is that the active pedestrian protection system must not only overcome the mass of the hood, but also the mass of the metal hinge components to deploy the hood to an active pedestrian position. To this end, a need exists to reduce the weight of the hinge for improving active pedestrian protection system deployment times, and the reduction in the output power and size of the actuator of the active pedestrian protection system, while providing an active hinge that can resist the rapid deployment forces imparted by the actuator on the hinge during an active pedestrian protection operation. In some active hinges, the actuator is used to hold the hood in its deployed position. For example, some active hinges use a pyrotechnic actuator which typically requires controlled venting to maintain the upward force that is applied to the pivot linkage. To this end, a need exists to provide alternative solutions for locating and retaining the hood in its deployed position which address and overcome shortcomings of conventional active hinges.

Additionally, it is desirable to provide hinges, such as hood hinges for a motor vehicle for example, which are lightweight and maintain the desired strength and stiffness characteristics matching or exceeding those of metal hinges. One known lightweight material alternative to metal employed in hinges is carbon fiber. However, some drawbacks associated with employing carbon fiber material with hinges include an increased manufacturing complexity and an increase in material costs compared to hinges formed using metal.

In recent years, attention has also been directed to development of powered configurations of a hood whereby a user does not have to manually move the hood, regardless of the hood's weight. Rather, an electric powered actuator may be provided to move the hood.

It is desired to continue to advance the art of hood technology so that the hood can be raised in both a normal operating condition, and an active pedestrian position.

### SUMMARY

This section provides a general summary of the disclosure and is not intended to be interpreted as a comprehensive listing of its full scope or all of its objects, aspects, features and/or advantages.

In accordance with an aspect, provided is a hood hinge for a vehicle hood panel configured to close off a space of a vehicle body, the hood hinge comprising a hood bracket for connection to the vehicle hood panel, a body bracket for connection to the vehicle body, and a pivot arrangement between the hood bracket and the body bracket, the pivot arrangement allowing the vehicle hood panel to move between a closed position, a normal open position, and a partially opened active pedestrian position, wherein the hood hinge is configured, in a normal mode, to move the vehicle hood panel from the closed position to the normal open position and from the normal open position to the closed position in response to an actuation force from a first actuator being applied to the vehicle hood panel, and, in an active pedestrian protection mode, to move the vehicle hood panel from the closed position to the partially opened active pedestrian position in response to the actuation force from the first actuator being applied to one of the vehicle hood panel or hood hinge.

In a related aspect, the hinge comprises a mounting point for connecting with the first actuator.

In a related aspect, the mounting point is located on the hood bracket.

In a related aspect, the first actuator comprises an electric motor and a geartrain.

In a related aspect, a pyrotechnic device is not provided for moving the vehicle hood panel from the closed position to the active pedestrian position.

In a related aspect, a deploy bracket is connected to the hood bracket and to the pivot arrangement, wherein the first actuator is configured to impart relative motion between the hood bracket and the deploy bracket during the active pedestrian protection mode.

In a related aspect, a lock device is coupled between the hood bracket and the deploy bracket, wherein the lock device is configured to be released by a second actuator to decouple the lock device from between the hood bracket and the deploy bracket.

In a related aspect, the second actuator includes an electric actuator.

In a related aspect, the first actuator comprises an extendable member that has an opening stroke for moving the vehicle hood panel to the normal open position, and an active pedestrian stroke for moving the vehicle hood panel to the partially opened active pedestrian position, where the active pedestrian stroke is less than the opening stroke.

In a related aspect, the hood bracket includes a mounting point connected to the extendable member of the first actuator.

In a related aspect, the mounting point comprises a ball configured for engagement with a ball socket of the extendable member.

In a related aspect, the first actuator includes a lead screw and a motor configured for rotation in a first direction for moving the extendable member toward an extended position and a second direction for moving the extendable member toward the retracted position.

In a related aspect, the vehicle hood panel is for closing off a frunk space.

In accordance with another aspect, provided is a hood hinge for a vehicle hood panel configured to close off a space of a vehicle body, the hood hinge comprising a hood bracket for connection to the vehicle hood panel, a body bracket for connection to the vehicle body, and a pivot arrangement between the hood bracket and the body bracket, the pivot arrangement allowing the vehicle hood panel to move between a closed position, a normal open position, and a partially opened active pedestrian position, and an actuator having an electric motor, wherein the actuator is configured to cause the hood hinge to fully expand in a normal mode to move the vehicle hood panel from the closed position to the normal open position and to collapse to move the vehicle hood panel from the normal open position to the closed position, wherein the actuator is further configured to cause the hood hinge to partially expand in an active pedestrian protection mode to move the vehicle hood panel from the closed position to the partially opened active pedestrian protection position.

### BRIEF DESCRIPTION OF THE DRAWINGS

The drawings described herein are for illustrative purposes only of selected embodiments and not all possible implementations thereof such that the drawings are not intended to limit the scope of the present disclosure.

FIG. 1 shows a side view of a motor vehicle having a hood hinge system for raising a hood in a normal mode to a normal open position and in an active pedestrian protection mode to a partially open pedestrian protection position, in accordance with aspects of the disclosure, with the hood shown in a fully closed position while in the normal mode;

FIG. 2 shows a side view of the motor vehicle of FIG. 1 with the hood hinge system raising the hood to the normal open position in the normal mode, in accordance with an aspect of the disclosure;

FIG. 3A shows an isolated enlarged side view of the hood hinge system of FIG. 1 in a non-deployed state while in the normal mode, with the hood held in its closed position, in accordance with an aspect of the disclosure;

FIG. 3B is a view similar to FIG. 3A with the hood hinge system shown including a secondary latch in accordance with another aspect of the disclosure;

FIG. 4 shows an isolated enlarged side view of the hood hinge system of FIG. 1 in a normally deployed state while in the normal mode, with the hood moved to its normal open position, in accordance with an aspect of the disclosure;

FIG. 5 shows a side view of the motor vehicle of FIG. 1 with the hood hinge system raising the hood to the partially open pedestrian protection position while in the active pedestrian protection mode upon an imminent collision with a pedestrian being detected, in accordance with an aspect of the disclosure; and

FIG. 6 shows an isolated enlarged side view of the hood hinge system of FIG. 5 in an active pedestrian protection state while in the active pedestrian protection mode, with the hood moved by the hood hinge system to its partially open active pedestrian position, in accordance with aspects of the disclosure.

### DETAILED DESCRIPTION OF EXAMPLE EMBODIMENTS

Example embodiments will now be described more fully with reference to the accompanying drawings.

Example embodiments of a vehicle hood assembly having a hood and at least one active hinge embodying the teachings of the present disclosure will now be described more fully with reference to the accompanying drawings. However, the example embodiments are only provided so that this disclosure will be thorough, and will fully convey the scope to those who are skilled in the art. Numerous specific details are set forth such as examples of specific components, devices, and methods, to provide a thorough understanding of embodiments of the present disclosure. It will be apparent to those skilled in the art that specific details need not be employed, that the example embodiments may be embodied in many different forms and that neither should be construed to limit the scope of the disclosure. In some example embodiments, well-known processes, well-known device structures, and well-known technologies are not described in detail.

As will be detailed, the active hinges and hinge components of the present disclosure may be used as part of a hood assembly for a pedestrian protection system on motor vehicles. More specifically, active hinges of the type disclosed herein are used for mounting a vehicle hood to a vehicle body in an effort to introduce an additional degree of freedom in the movement of the vehicle's hood when a pedestrian is struck by the vehicle to reduce the severity of injuries sustained when the pedestrian contacts the vehicle's hood. The active hinges and hinge components of the present disclosure may be used as part of a conventional hood assembly without a pedestrian protection system on motor vehicles. The active hinges of the present disclosure may also be used for other types of closure panels for a motor vehicle, such as for example and without limitation, a frunk, a trunk, a side door, a glove compartment or other storage compartment panel, and the like.

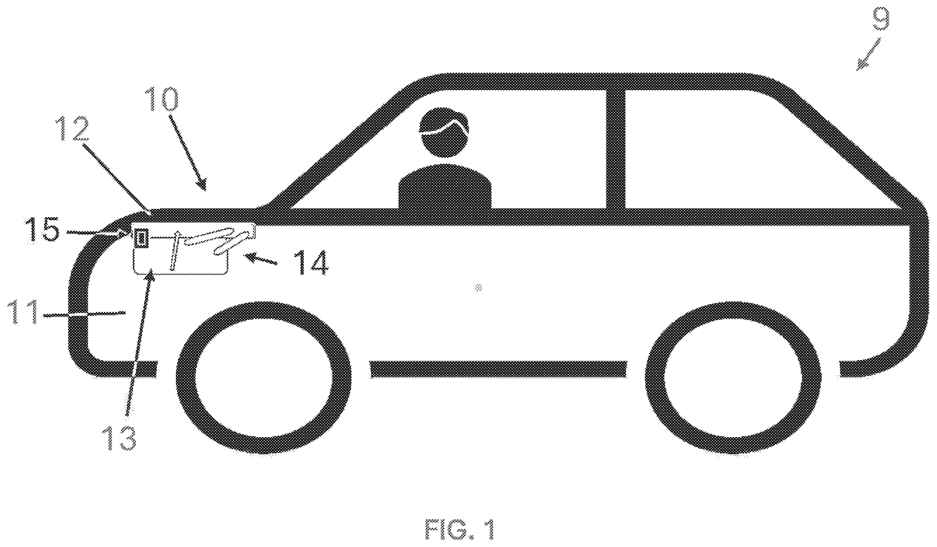

FIG. 1 illustrates a side elevational view of a vehicle hood assembly 10 for a motor vehicle 9 as generally configured to include a vehicle panel, illustratively shown as a hood 12 and at least one hood hinge, referred to hereafter as hinge 14, such as an active or a passive hinge 14. The term “vehicle” is intended to broadly encompass any car, truck, SUV, van or any other type of passenger carrying vehicle. Hood assembly 10 is configured to overlie a compartment 13 of the vehicle 9, such as an engine compartment or a storage compartment without an engine also known as a “frunk” (a portmanteau word formed from blending the words “front trunk”), as defined by the vehicle's body 11. As is conventional, a front segment of hood 12 is configured to be located proximate to a front portion, also referred to as front segment 16, of the vehicle whereat a latch and striker arrangement, also referred to as primary latch 15, can releasably retain the hood 12 to the vehicle body 11 while rear segment of the hood 12 is configured to be located proximate to the vehicle's windshield whereat at least one hinge 14 may be secured.

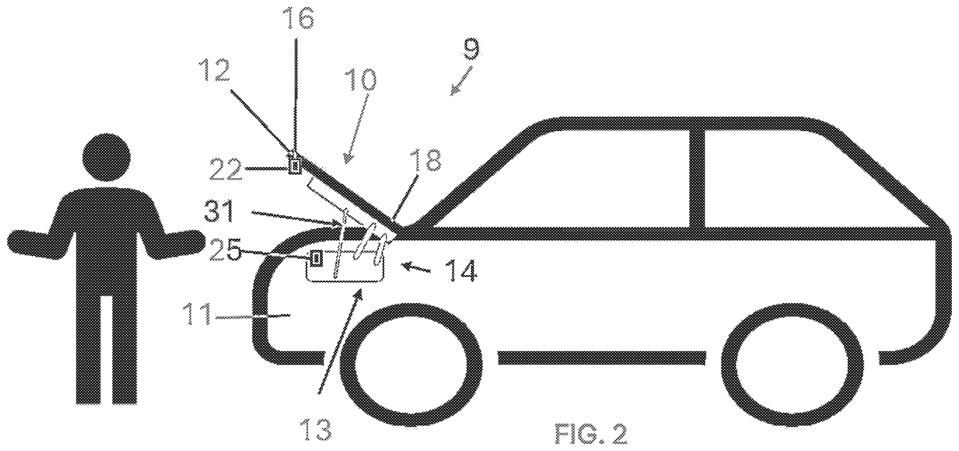

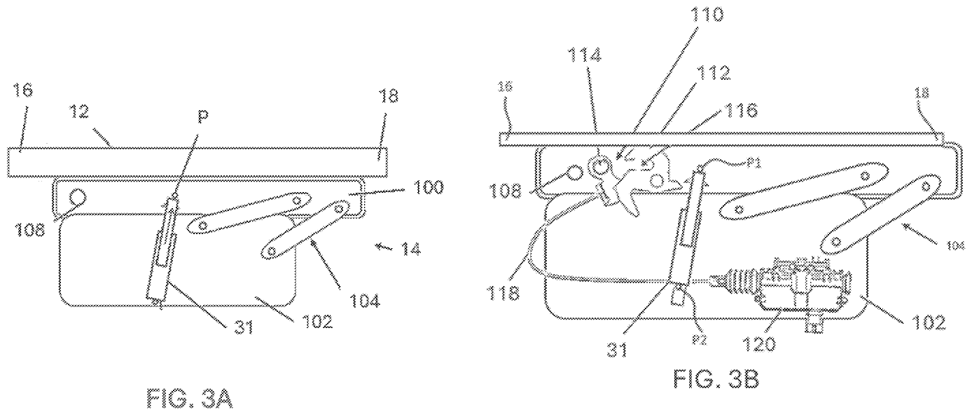

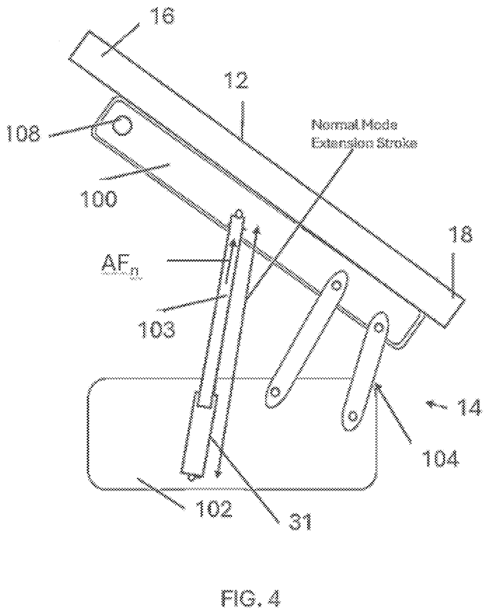

In accordance with one example embodiment, and with further reference to FIGS. 3A, 3B and FIG. 4, the at least one hinge 14, which may be active or passive hinges, are associated with hood assembly 10, each being located adjacent to one of the rear segments of hood 12 and being configured to allow hood 12 to pivot between a normal fully open position with a front segment 16 of hood 12 elevated (see FIG. 2 and FIG. 4) while in a normal mode (no collision/no accident) to provide access to compartment 13, such as a stowage or engine compartment, and a normal-closed position (see FIGS. 1, 3A, and 3B) whereat hood 12 is lowered to provide an unobstructed view for the person operating the vehicle 9. FIG. 1 illustrates an active hinge 14 positioned such that hood 12 pivots in proximity to a rear segment 18 of hood 12. The primary hood latching device 15 is shown to include a striker 22 fixed to an underside portion of front segment of hood 12 and a latch 24 mounted to a structural portion of the vehicle's body 11. In particular, FIG. 1 illustrates striker 22 engaged and held by latch 24 so as to locate hood assembly 10 in its normal-closed position with active hinge 14 maintained in a “non-deployed” condition, whereby front segment 16 of hood 12 is latched and rear segment 18 of hood 12 is located in its normal and conventional lowered position.

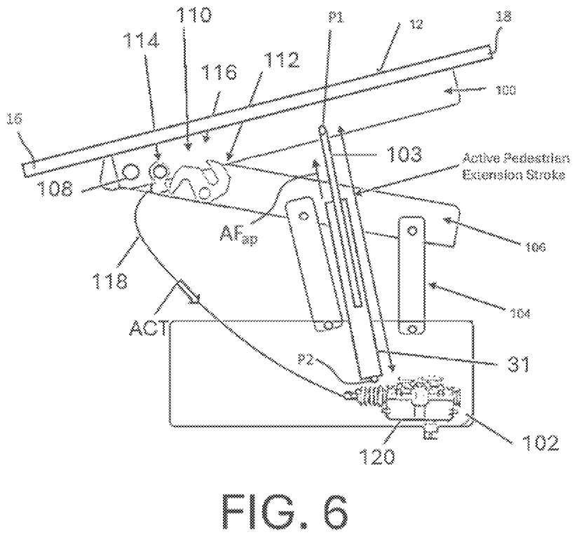

Active hinge 14 illustratively includes a hood bracket 100 connected to the hood 12 and a body bracket 102 connected to the vehicle body 11. The hood bracket 100 and the body bracket 102 are configured to pivot relative to each other, and for example during a normal mode when the hood 12 is being moved between closed and open positions as shown, respectively, in FIG. 1 and FIG. 2. Hood bracket 100 illustratively includes a pair of links 104 pivotally connected between the hood bracket 100 and the body bracket 102, thereby establishing a four-bar linkage, as an example of at least a portion of a pivot arrangement, to facilitate pivoting of the hood 12 relative to the vehicle body 11 during normal operation. Illustratively, the pair of links 104 are pivotally connected to a deploy bracket 106 (best seen in FIG. 6) forming another portion of pivot arrangement, with the deploy bracket 106 pivotally connected at a pivot 108 to the hood bracket 100 proximate the front segment 16 of hood 12. During the normal mode, deploy bracket 106 and hood bracket 100 remain fixed together against relative movement such that there is no relative rotation between deploy bracket 106 and hood bracket 100 about pivot 108.

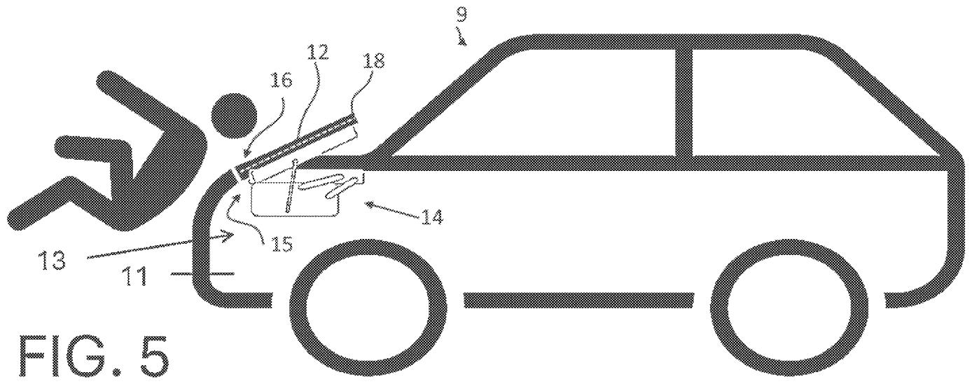

Active hinge 14 includes a powered actuator 31, also referred to as a first actuator, connected for selectively controlled telescopic movement between the body bracket 102 and the hood bracket 100, both during normal mode of operation causing the hood 12 to be moved to the normal open position (FIGS. 2 and 4), and during an active pedestrian protection mode, where an imminent collision is detected (FIGS. 5 and 6), as discussed in further detail below. Illustratively, powered actuator 31 is a spindle having a telescopically extendable member, such as a lead screw 103 driven for rotation in two directions when an electric motor of the powered spindle rotates in a corresponding one of two directions. One example of powered actuator 31 is shown and described in United States of America Patent Publication No. US20220136294A1 titled “Counterbalance mechanism with optional watershield, kicker spring, friction bearing, and fail safe spring retention mechanism”, the entire contents of which are incorporated herein by reference. Hood bracket 100 has a mounting connection, also referred to as mounting point P, connected to an end of extendable member 103. The mounting point P can be provided as a ball attached to hood bracket 100, wherein the ball is configured for pivotal connection to a ball socket coupled to the end of extendable member 103. The actuating force from the powered actuator 31 for moving the vehicle panel 12 may in one possible configuration be applied to the hood 12 indirectly through the actuating force being applied to the hood bracket 100 mounted to the hood 12. Powered actuator 31 may be mounted also at an opposite end to the body bracket 102. In another possible configuration, powered actuator 31 may be mounted also at an opposite end to the vehicle body 11. The actuating force for moving the vehicle panel 12 may in accordance with another possible configuration be applied directly to the hood 12, or to another bracket other than the hood bracket 100. In another possible configuration, powered actuator 31 may be mounted to the vehicle hood panel 12 directly (e.g. not via the hood bracket 100), and at an opposite end to the vehicle body 11. The actuating force from the single electrically operated actuator e.g. the powered actuator 31 causes the active hinge 14 to shift between its non-deployed state and its deployed active pedestrian protection state when the lock device (e.g. secondary latch 110) is in an unlocked state, and the actuation force AFₙ from the single electrically operated actuator causes the active hinge 14 to shift between its non-deployed state and its normally deployed state when the lock device (e.g. secondary latch 110) is in a locked state. The actuating force AFₙ from the single electrically operated actuator may be a lifting force and/or a closing force.

The extendable member 103 is configured for driven linear movement by a motor of powered actuator 31, and optionally a gear arrangement within powered actuator 31, between extended and retracted states in response to rotation of a drive member, such as a nut arranged in threaded engagement with external threads of the lead screw 103 or via a plurality of balls disposed within mirrored ball grooves of the lead screw 103 and the nut, by way of example and without limitation.

Selective actuation of powered actuator 31 drives lead screw 103 in extension away from body bracket 102 to move the hood 12 to the open position in response to powering a motor housed within the powered actuator 31. The powered actuator 31 is configured to operate in two modes, as noted above: the normal mode and the active pedestrian protection mode. In the normal mode of operation of the powered actuator 31, the extendable member 103 is configured to fully extend over an opening stroke to move the front segment 16 of hood 12 from a closed position (FIG. 3A and FIG. 3B) to a fully opened position (FIGS. 2 and 4) to provide open access from the front of the motor vehicle 9 to the compartment 13 beneath the hood 12. In the normal mode of operation of the powered actuator 31, the extendable member 103 is also configured to fully retract over a closing stroke to move the front segment 16 of hood 12 from the open position (FIG. 4) back to the fully closed position (FIGS. 3A, 3B). Active hinge 14 is shown in a collapsed state corresponding to the closed position of the closure panel 12 shown in FIGS. 3A and 3B. Active hinge 14 is shown in a fully expanded state corresponding to the fully open position of the closure panel 12 shown in FIG. 4. Active hinge 14 is shown in a partially expanded state corresponding to the partially open position, or active pedestrian protection position of the closure panel 12 shown in FIG. 6. In an active pedestrian protection mode of operation of the powered actuator 31, a less than full extension of the extendable member 103 will occur over an active pedestrian protection stroke that is less than the normal opening stroke in order to raise the rear segment 18 of hood 12 to an active pedestrian protection position. The operation of the powered actuator 31, therefore, provides a purely mechanical mechanism for raising the hood 12 during both the normal mode and during the active pedestrian protection mode. As a result, no pyrotechnic actuator is needed to move the hood 12 to the active pedestrian protection position.

Powered actuator 31 will be controlled (e.g. via a controller) to extend from the retracted position (see FIG. 5) to the active pedestrian protection position. Powered actuator 31 will be controlled automatically via one or more sensors in the event of an imminent vehicle impact with a pedestrian (FIG. 5), such as discussed in co-owned U.S. application Ser. No. 17/576,811, filed on Jan. 14, 2022 and issued as U.S. Pat. No. 11,781,349, the content of which is incorporated herein by way of reference. Specifically, powered actuator 31, in response to an imminent collision with a pedestrian, functions to shift active hinge 14 from its non-deployed state into a “deployed” condition, as shown in FIG. 6, where rear segment 18 of hood 12 is moved to a raised or deployed position while front segment of hood 12 remains latched via primary latch 15. Powered actuator 31 applies an actuation force AFₐₚ during the active protection mode. Thus, active hinge 14 provides an additional degree of freedom in its movement to permit rear segment 18 of hood 12 to move from its normal lowered position (FIG. 3B) to its raised pedestrian protection position (FIGS. 5 and 6). As will also be detailed, under normal operating situations (i.e., no imminent pedestrian collision detected), this additional degree of freedom is disabled by a secondary latch 110 of a latching mechanism associated with active hinge 14 which, in turn, permits normal usage of hood 12, by preventing rotation of hood bracket 100 relative to deploy bracket 106 about pivot 108, thereby functioning as a releasable lock mechanism between the hood bracket 100 and the deploy bracket 106. Illustratively, secondary latch 110 includes a ratchet 112 pivotally mounted to the deploy bracket 106 and a pawl 114 pivotally mounted to the hood bracket 100. When pawl 114 is in locking position with the ratchet 112, ratchet 112 is secured to a striker, such as provided as a pin or post 116, by way of example and without limitation, mounted to the hood bracket 100, and thus, relative motion between the body bracket 102 and the deploy bracket 106 about pivot 108 is prevented. When pawl 114 is in an unlocking position with the ratchet 112, ratchet 112 is able to release the post 116 mounted to the hood bracket 100, and thus, relative motion between the body bracket 102 and the deploy bracket 106 about pivot 108 is permitted. Movement of the pawl 114 from the locking position to the unlocking position may occur by activation ACT (FIG. 6) of a cable 118 connected to a release actuator 120, also referred to as a second actuator. Second actuator may be configured illustratively as having an electric motor, and may include a geartrain driven by the electric motor. Second actuator may be configured illustratively as having an electric solenoid. Second actuator may be configured illustratively as having a pyrotechnic device. Normal usage or normal mode is understood to mean pivotal movement of hood 12 between its normally-closed position of FIG. 1 and a normally-opened position of FIG. 2 while active hinge 14 is maintained in its non-deployed state (e.g. pawl 114 in locking position with ratchet 112 to maintain pin 116 in latched position such that hood bracket 100 and deploy bracket 106 are locked together against pivotal movement about pivot 108). Release of the secondary latch 110 (via selective actuation of actuator 120) functions to initiate shifting of active hinge 14 from its non-deployed state to its deployed state, followed by controlled extension of the spindle 31 in an active pedestrian protection mode, whereby the extension distance of the extendable member 103 is limited so as not to raise the hood 12 beyond the active pedestrian protection position (FIG. 6). A predictive or anticipatory sensed pedestrian impact sensor system, as discussed above, may be used to control the release of the secondary latch 110 and then the deployment of the spindle 31 to the active pedestrian protection extended position to allow for the slightly slower response time of the motor based spindle 31 compared to that of an explosive type actuator such as a pyrotechnic device. It is recognized that the teachings herein may be applied to other types of hinges, for example a passive hinge, which is in other words a hinge not provided with a pedestrian protection device functioning to automatically deploy the hinge in the event of a vehicle impact with a pedestrian. A passive type hinge may be manually operated, for example by a user moving the hood 12 manually, or powered for example by a powered actuator moving the hood 12.

Active hinge 14 is configured to allow this additional degree of freedom in the movement of hood 12 in response to a vehicle/pedestrian collision, but without use of an explosive pyrotechnic. For example, a pyrotechnic device (e.g. a chemically actuated device) is not provided between the hood bracket 100 and the body bracket 102 in order to expand the active hinge 14 to the active pedestrian protection state. The potential for damage to hinge components 14 may thus be reduced due to not experiencing high force explosive impacts from pyrotechnic explosions, as well as being able to be constructed of less robust and lower cost components compared to hinges having to withstand the higher force impacts due to use of an explosive charge from a pyrotechnic device. Furthermore, a cost savings of eliminating the pyrotechnic device from the hood system 10 results, as the spindle 31 is now used during both the normal mode of the hood system 10 and the active pedestrian protection mode of the hood system 10. In addition, active hinge 14 provides a mechanism for mechanically maintaining its deployed condition following the pedestrian protection collision event through the internal gearing and/or internal counterbalancing springs of the spindle 31. Furthermore, a reset function is provided by which the secondary latch 110 is released and the primary latch 15 is engaged so as to return active hinge 14 to its non-deployed condition.

The terminology used herein is for the purpose of describing particular example embodiments only and is not intended to be limiting. As used herein, the singular forms “a,” “an,” and “the” may be intended to include the plural forms as well, unless the context clearly indicates otherwise. The terms “comprises,” “comprising,” “including,” and “having,” are inclusive and therefore specify the presence of stated features, integers, steps, operations, elements, and/or components, but do not preclude the presence or addition of one or more other features, integers, steps, operations, elements, components, and/or groups thereof. The method steps, processes, and operations described herein are not to be construed as necessarily requiring their performance in that particular order discussed or illustrated, unless specifically identified as an order of performance. It is also to be understood that additional or alternative steps may be employed.

When an element or layer is referred to as being “on,” “engaged to,” “connected to,” or “coupled to” another element or layer, it may be directly on, engaged, connected or coupled to the other element or layer, or intervening element or layers may be present. In contrast, when an element is referred to as being “directly on,” “directly engaged to,” “directly connected to,” or “directly coupled to” another element or layer, there may be no intervening elements or layers present. Other words used to describe the relationship between elements should be interpreted in a like fashion (e.g., “between” versus “directly between,” “adjacent” versus “directly adjacent,” etc.). As used herein, the term “and/or” includes any and all combinations of one or more of the associated listed items.

Although the terms first, second, third, etc. may be used herein to describe various elements, components, regions, layers and/or sections, these elements, components, regions, layers and/or sections should not be limited by these terms. These terms may be only used to distinguish one element, component, region, layer or section from another region, layer or section. Terms such as “first,” “second,” and other numerical terms when used herein do not imply a sequence or order unless clearly indicated by the context. Thus, a first element, component, region, layer or section discussed below could be termed a second element, component, region, layer or section without departing from the teachings of the example embodiments.

Spatially relative terms, such as “inner,” “outer,” “beneath,” “below,” “lower,” “above,” “upper,” and the like, may be used herein for ease of description to describe one element or feature's relationship to another element(s) or feature(s) as illustrated in the figures. Spatially relative terms may be intended to encompass different orientations of the device in use or operation in addition to the orientation depicted in the figures. For example, if the device in the figures is turned over, elements described as “below” or “beneath” other elements or features would then be oriented “above” the other elements or features. Thus, the example term “below” can encompass both an orientation of above and below. The device may be otherwise oriented (rotated 90 degrees or at other orientations) and the spatially relative descriptors used herein interpreted accordingly.

The foregoing description of the embodiments has been provided for purposes of illustration and description. It is not intended to be exhaustive or to limit the disclosure. The term “Plastic” is considered to be inclusive of any non-metallic material capable of being molded. Individual elements or features of a particular embodiment are generally not limited to that particular embodiment, but, where applicable, are interchangeable and can be used in a selected embodiment, even if not specifically shown or described. For example, the various hinge components described herein may be provided each with the teachings of the various embodiments, such as they may be provided as examples with one or more array structures, with metal reinforcing inserts or sleeves surrounding apertures, with metal or other planar cores, and generally hinge components provided with a planar structure with out of plane extending structures having varying densities along the planar structure for providing strength and stiffness at portions of the hinge component subjected to higher loading, such as about apertures for receiving fasteners, and weight reduction by not providing out of plane extending structural density for portions of the hinge component not subjected to or subjected to lesser loading forces. The same may also be varied in many ways. Such variations are not to be regarded as a departure from the disclosure, and all such modifications are intended to be included within the scope of the disclosure.

What is claimed is:

1. A hood hinge for a vehicle hood panel configured to close off a space of a vehicle body, the hood hinge comprising:
a hood bracket for connection to the vehicle hood panel;
a body bracket for connection to the vehicle body; and
a pivot arrangement between the hood bracket and the body bracket, the pivot arrangement allowing the vehicle hood panel to move between a closed position, a normal open position, and a partially opened active pedestrian protection position;
wherein the hood hinge is configured, in a normal mode, to move the vehicle hood panel from the closed position to the normal open position and from the normal open position to the closed position in response to an actuation force from a first actuator being applied to the vehicle hood panel, and, in an active pedestrian protection mode, to move the vehicle hood panel from the closed position to the partially opened active pedestrian protection position in response to the actuation force from the first actuator being applied to the one or the vehicle hood panel and hood hinge.

2. The hood hinge of claim 1, wherein the hinge comprises a mounting point for connecting with the first actuator.

3. The hood hinge of claim 2, wherein the mounting point is located on the hood bracket.

4. The hood hinge of claim 1, wherein the first actuator comprises an electric motor and a geartrain.

5. The hood hinge of claim 4, wherein a pyrotechnic device is not provided for moving the vehicle hood panel from the closed position to the active pedestrian protection position.

6. The hood hinge of claim 1, further comprising a deploy bracket connected to the hood bracket and to the pivot arrangement, wherein the first actuator is configured to impart relative motion between the hood bracket and the deploy bracket during the active pedestrian protection mode.

7. The hood hinge of claim 1, further comprising a lock device coupled between the hood bracket and the deploy bracket, wherein the lock device is configured to be released by a second actuator to decouple the lock device from between the hood bracket and the deploy bracket.

8. The hood hinge of claim 7, wherein the second actuator includes an electric motor.

9. The hood hinge of claim 1, wherein the first actuator comprises an extendable member that has an opening stroke for moving the vehicle hood panel to the normal open position, and an active pedestrian protection stroke for moving the vehicle hood panel to the partially opened active pedestrian protection position, where the active pedestrian protection stroke is less than the opening stroke.

10. The hood hinge of claim 9, wherein the hood bracket includes a mounting point connected to the extendable member of the first actuator.

11. The hood hinge of claim 10, wherein the mounting point comprises a ball configured for engagement with a ball socket of the extendable member.

12. The hood hinge of claim 9, wherein the first actuator includes a lead screw and a motor configured for rotation in a first direction for moving the extendable member toward an extended position and a second direction for moving the extendable member toward the retracted position.

13. The hood hinge of claim 1, wherein the vehicle hood panel is for closing off a frunk space.

14. A hood hinge for a vehicle hood panel configured to close off a space of a vehicle body, the hood hinge comprising:
a hood bracket for connection to the vehicle hood panel;
a body bracket for connection to the vehicle body;
a pivot arrangement between the hood bracket and the body bracket, the pivot arrangement allowing the vehicle hood panel to move between a closed position, a normal open position, and a partially opened active pedestrian protection position; and
an actuator having an electric motor;
wherein the actuator is configured to cause the hood hinge to fully expand in a normal mode to move the vehicle hood panel from the closed position to the normal open position and to collapse to move the vehicle hood panel from the normal open position to the closed position, wherein the actuator is further configured to cause the hood hinge to partially expand in an active pedestrian protection mode to move the vehicle hood panel from the closed position to the partially opened active pedestrian protection position.
